(19) United States
(12) Patent Application Publication
(10) Pub. No.: US 2010/0254211 A1
(43) Pub. Date: Oct. 7, 2010

(54) PROCESSING DEVICE FOR BULK MATERIAL

(75) Inventor: Michael Zlotos, Biblis (DE)

Correspondence Address: Mann+Hummel GMBH;Department VR-P, Hindenburgstr. 45, Ludwigsburg, 71638, DE

(73) Assignee: MANN+HUMMEL GMBH, Ludwigsburg (DE)

(21) Appl. No.: 12/752,435

(22) Filed: Apr. 1, 2010

(30) Foreign Application Priority Data
Apr. 1, 2009 (DE) 102009015271.7-23

(51) Int. Cl. B01F 13/02; B01F 15/06

(52) U.S. Cl. 366/101

(57) ABSTRACT

A processing device for conveying and mixing bulk material has a mixing and conveying station and at least one conveying pipe for supplying the bulk material to the mixing and conveying station. A vacuum-generating system with a vacuum hose or pipe is connected to the mixing and conveying station. An air supply is connected to the mixing and conveying station and introduces air for conveying and mixing the bulk material. A screen is arranged within said mixing and conveying station for separating the bulk material from the air. The screen has screen openings matched to a desired level of separation. The air from the air supply flows into the bulk material and effects mixing of the bulk material and removal of dust from the bulk material. The air has a temperature of 40 degrees C. to 200 degrees C.

### CROSS REFERENCE TO RELATED APPLICATIONS

This application claims the benefit under 35 USC 119 of foreign application 10 2009 015 271.7 filed in Germany on Apr. 1, 2009, and which is hereby incorporated by reference in its entirety.

### TECHNICAL FIELD

The invention relates to a processing device for bulk material.

### BACKGROUND OF THE INVENTION

DE 40 29 902 discloses a device and a method for conveying and mixing bulk material. For this purpose, a container that tapers in the downward direction is provided that comprises a bottom closure plate. A suction blower arranged outside of the container generates underpressure (vacuum) in the container. By means of a conveying pipe system the bulk material to be conveyed is supplied. In this device at least two conveying pipes within the conveying pipe system are provided and they each have a conveying valve. With the aforementioned device mixing of the bulk material can be performed. Additional functions are not fulfilled by this conveying device.

DE OS 20 26 337 also discloses a method for mixing a basic substance in powder form with additives of the same kind. In this method, first the basic substance is conveyed by a suction air stream through a supply socket into the container. After the deposited layer of basic substance in the container has reached a certain level sufficient to provide a satisfactory slow-down or throttling action, a closure member is opened and the additives that are dispensed by a metering device are sucked into the funnel. The carrying air that is loaded with the additives exits through the mouth and rises, finely dispersed, upwardly through the basic substance layers positioned above wherein the carrying air releases the additives slowly into the basic substance. Mixing or swirling of the substances with one another does not take place.

Moreover, DE 25 44 716 A1 discloses a suction conveyor with a pneumatic mixer. The components are conveyed separately and weighed and, after completion of a conveying cycle, are layered on top one another. Upon completion of the supply of the components, an appropriate venting valve causes pneumatic mixing of the components. This process requires several steps that are performed sequentially so that a relatively long conveying and mixing time is required.

### SUMMARY OF THE INVENTION

It is therefore an object of the present invention to avoid the aforementioned disadvantages and to provide a processing device for bulk material which is characterized by a simple configuration and, on the one hand, ensures a reliable mixing of the bulk material while, on the other hand, the bulk material is prepared such that an optimal processing in a subsequent processing machine is ensured.

In accordance with the present invention, this is achieved in that the processing device for bulk material, in particular for conveying and mixing bulk material, comprises a mixing and conveying station, at least one conveying pipe for supplying the bulk material to be conveyed, wherein the mixing and conveying station is connected to a vacuum hose or pipe and the vacuum hose or pipe is arranged on a vacuum-generating system, wherein air for conveying and/or mixing is supplied and, for separating the bulk material from the air, a screen is provided within the mixing and conveying station, wherein the screen has screen openings matched to a desired level of separation for separating the bulk material from the air, and wherein air flows into the bulk material and effects mixing of the bulk material and removal of dust from the bulk material, and wherein the air has a temperature of 40 degrees C. to 200 degrees C.

The important advantage of the invention resides and that not only mixing of the bulk material is realized but also at the same time dust is removed from the bulk material. For this purpose, a screen is provided in the area where the air is removed and the screen has appropriate screen openings so that dust that is possibly contained in the bulk material will escape through these openings and is sucked away so that an additional function of the processing device according to the present invention resides in dust removal. By supplying hot air the quality of the dust removal action is improved.

The material to be processed, i.e., the bulk material to be mixed, is either sucked in (drawn in under vacuum) directly from containers and supplied to the mixing and conveying device or is supplied from cutting mills (granulators) or shredders to the mixing and conveying device. By mixing of the material and suction removal of the air, the material is swirled and mixed through. At the same time, undesirable fine particles become detached from the material mixture and can be removed by suction. The level of dust removal is determined by means of different screens that are employed in the mixing and conveying station.

A further important advantage of the invention resides in that a different processes, such as conveying, metering, mixing, and removing dust, can be performed in a single device in a cost-efficient manner. Accordingly, injection molding and extrusion processes become less time-consuming because the material preparation is realized in parallel and very clean material can be employed. By means of the homogenous mixing action of different material components the number of low quality articles or even rejects is reduced and the product quality is improved. Nesting of dust or fine particles is prevented reliably.

A further important advantage resides in that the existing filter systems do not clog and that a smaller fine particle proportion is present in the conveyed bulk material so that a more homogenous process is ensured.

Advantageously, this method is employed for mixing granular plastics and supplying granular plastics into a plastics injection molding machine.

According to a further embodiment of the invention, a valve is provided on a conveying pipe. By means of this valve, air for mixing and removing dust is supplied; a time-based and quantity-based control or regulation is possible.

According to an alternative, a supply air pipe for supplying air for the purpose of mixing and removing dust is provided on the conveying station. This supply air pipe is provided with a valve with which the mixing time, i.e., the time for supplying air and at the same time also the quantity of the supplied air can be adjusted.

According to another embodiment, the mixing and conveying station is provided with a bottom closure plate. By means of this closure plate the mixed bulk material is removed and, for example, supplied to a plastics injection molding machine or generally to another processing station.

One embodiment of the invention provides that a further conveying pipe for conveying a further component of the bulk material is provided. In this way, in parallel or sequentially two different products can be supplied to the mixing and conveying station. For example, through a conveying pipe a granular plastic material in the form of new material can be supplied and by means of a further conveying pipe ground plastics scrap can be supplied. Especially in case of ground plastics scrap the dust proportion is relatively high so that dust removal will improve the quality of ground plastics scrap and the quality of the bulk material as a whole significantly.

The mixing and conveying device has arranged downstream thereof a system for generating underpressure (vacuum). It is comprised of a suction blower as well as a receptacle for the dust that has been removed. Between the suction blower and the receptacle a filter in the form of a filter element or a cyclone separator is provided. At this location the dust is separated from the conveying air. The dust collector also has a bottom closure plate or flap in order to dispose of or remove the collected dust.

The mixing and conveying device according to a further advantageous embodiment of the invention is placed as a compact unit directly or indirectly onto processing machines such as injection molding machines, blow molding machines or other machines for processing plastics. There is also the possibility to use the device with which dust is removed from the granular plastics as an independent unit or as an additional dust removal unit in plastics conveying and plastics processing.

These and additional features may be taken from the dependent claims as well as from the description and the drawings.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 shows a multi-function device for conveying and mixing of granular plastics material for removing dust from the bulk material, consistent with the present invention; and

FIG. 2 shows in a schematic illustration the supply of hot air, consistent with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of apparatus components related to a processing device for bulk material. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

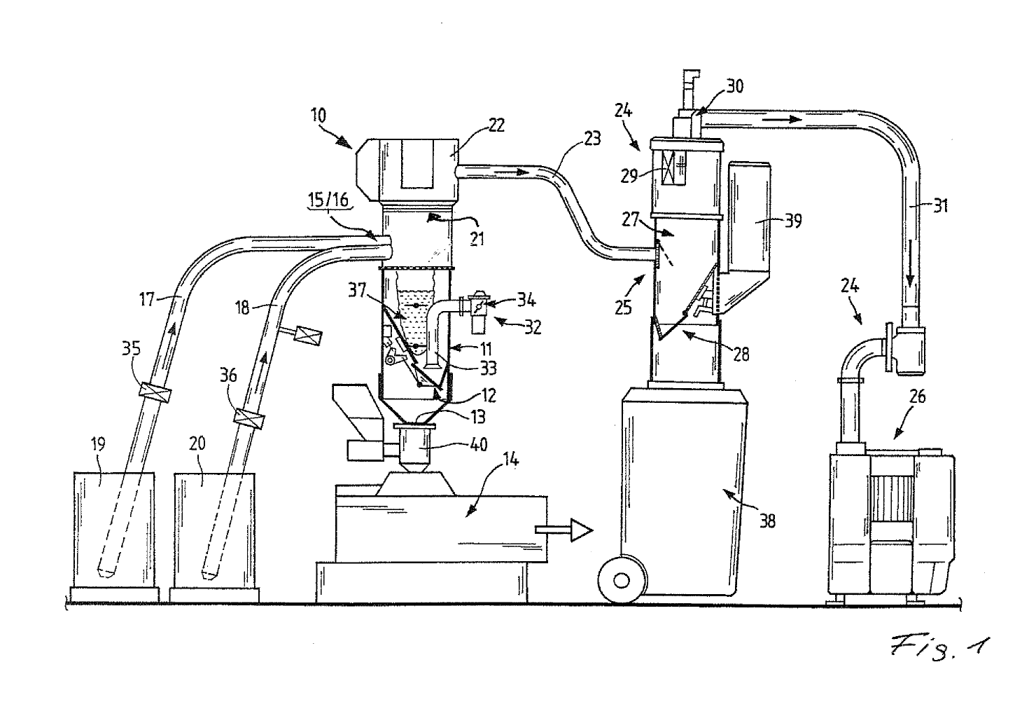

According to FIG. 1, a mixing and conveying device 10 is provided, comprised of a container 11 that is provided with a bottom closure plate 12 and an outlet 13 that is arranged below the bottom closure plate 12. The outlet 13 is connected to a plastics processing unit 14, for example, a metering screw conveyor for a plastics injection molding device. Between the plastics processing unit 14 and the outlet 13 optionally a metering device 40, only schematically indicated, can be provided for adding further material. The container 11 has openings 15, 16 to which are connected conveying pipes 17, 18, respectively. The conveying pipes 17, 18 extend to containers 19, 20 in which granular plastics material is contained. This granular plastics material can be new material but may also include ground plastics scrap. Above the openings 15, 16 of the container 11 a screen 21 is provided. Above the screen 21 there is a suction chamber 22 in communication with a vacuum hose 23. The vacuum hose 23 extends to a system 24 for generating underpressure (vacuum) that is comprised of a dust separator 25 and a suction blower 26.

The dust separator 25 is embodied like a conventional vacuuming device, i.e., it has a dust collecting container 27 that is provided with a closure flap 28 for removing the collected dust. In the upper area the dust separator 25 is provided with a filter cartridge 29 that separates the dust collecting chamber or raw air chamber from the clean air chamber 30. The clean air chamber 30 is connected to a clean air conduit 31. The clean air conduit 31 extends to a suction blower 26 that, on the one hand, ensures that the bulk material contained in the containers 19, 20 is supplied to the container 11 and, on the other hand, the dust-containing air is purified. On the container 11 there is moreover a foreign air supply 32, comprised of a pipe 33 projecting into the bulk material and extending through the container wall of the container 11 to the exterior; a valve 34 closes off or opens the pipe 33 to air flow.

The function of the multi-function device is described in the following.

After turning on the suction blower 26, from the container 19 or 20, or simultaneously from both containers, depending on the position of the closure valves 35, 36, granular plastics material or ground plastics scrap is transported into the mixing and conveying device 10. The bulk material is deposited on the bottom closure plate and fills the container to a certain maximum filling level. For mixing and removing dust, simultaneously with the valves 35, 36 being open or after the valves 35, 36 have been closed, the valve 34 is opened so that pressurized foreign air will flow into container 11 and cause the mixing of the bulk material and at the same time removal of the dust from the bulk material 37 contained in the container. So that no bulk material can pass into the vacuum hose 23 or the suction chamber 22, a screen 21 is arranged upstream thereof. This screen 21 has screen openings of a mesh size or width that enables, on the one hand, removal of dust into the vacuum chamber 22 and, on the other hand, prevents removal of bulk material that is larger than a given grain size. In this connection, it is possible to design the screen with different mesh sizes or to insert different screens into the mixing and conveying device. After a satisfactory mixing of the bulk material has taken place and at the same time dust has been removed from it, the valve 34 is closed. By opening the bottom closure plate 12 the bulk material can be supplied to the plastics processing unit 14. The dust that has been removed from the mixing and conveying device 10 reaches the dust separator 25, is collected therein in the dust collecting container 27, and can pass through the closure flap 28 downwardly to the dust collector 38. The dust is retained by a filter cartridge 29 of the type conventional in a vacuuming device. The filter cartridge ensures that only clean air is supplied to the suction blower 26; the air is subsequently released into the atmosphere. On the dust separator 25 a compensation filter 39 for pressure compensation is provided. For the purpose of removing dust from the bulk material 37 the supply of air can be regulated or controlled by opening the valve 34 to a greater or lesser extent, i.e., an intensive or less intensive swirling of bulk material takes place, depending on the type of bulk material contained in the container 11.

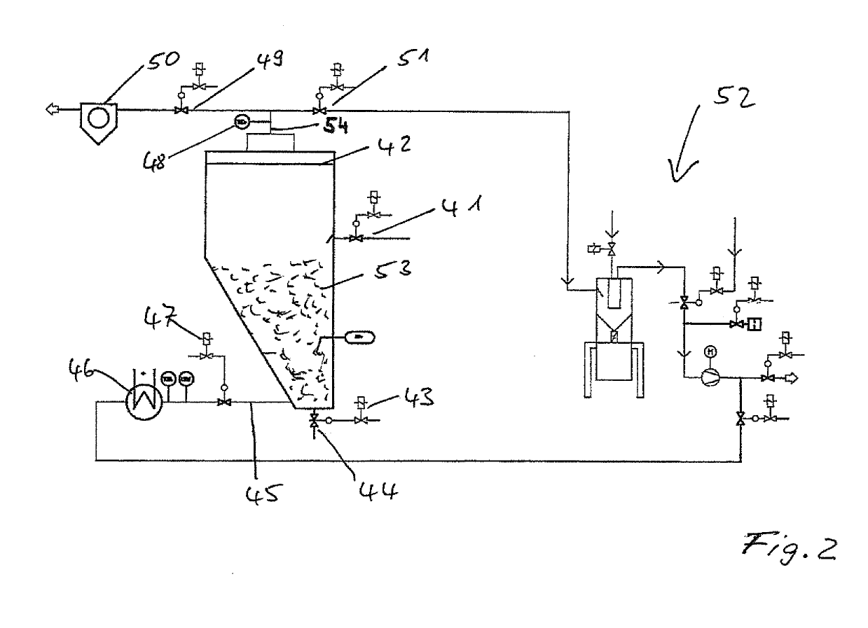

FIG. 2 shows a device with supply of hot air. This device has a container 53 provided with a material inlet 41 and a screen 42 in the upper area. At the geodetically lower end, the container 53 is provided with an outlet valve 43; such a valve 43 is, for example, a pneumatic slide 44 (in one embodiment, FIG. 2 shows a solenoid valve pointed to by 43 controlling air to pneumatically operated slide valve 44). At the left side, a hot air supply 45 is connected to the container 53. This supply has a heater 46. Moreover, a supply valve 47 (shown here as a pneumatically operated valve with air controlled by a solenoid) is arranged on the hot air supply 45 in order to supply additional air. In the upper area of the container 53 an exhaust air conduit 54 is provided. This exhaust air conduit 54 is provided with a temperature measuring device 48 for measuring the temperature of the exhaust air. The exhaust air conduit 54 extends to the left to an air suction device 50; valve 49 is provided in the conduit 54. The air that is exhausted here can pass through a dust collecting container, not illustrated, to the exterior. At the right side a valve 51 is provided. When this valve 51 is open and the valve 49 closed, the sucked-away air is supplied to a central filter system 52. This central filter system is illustrated also in FIG. 1 to the right of the mixing device 10 and is known in general. The flow of air entering via the hot air supply 45 causes the bulk material in the container 53 to swirl. At the same time, the hot air ensures that dust is removed from the bulk material or, at higher temperature, causes a crystallization of the bulk material that is being swirled within the container.

The advantage of hot air for dust removal resides in that material of different degrees of moisture contained in the container can be freed from dust in a simple and quick way, i.e., the dust removal time is shortened and the dust removal action is qualitatively improved.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A processing device for conveying and mixing bulk material, comprising:
a mixing and conveying station;
at least one conveying pipe for supplying the bulk material to said mixing and conveying station;
a vacuum-generating system comprising a vacuum hose or pipe that is connected to said mixing and conveying station;
an air supply connected to said mixing and conveying station for conveying and/or mixing the bulk material; and
a screen, arranged within said mixing and conveying station, for separating the bulk material from the air;
wherein said screen has screen openings matched to a desired level of separation for separating the bulk material from the air; and
wherein air from said air supply flows into the bulk material and effects mixing of the bulk material and removal of dust from the bulk material, wherein the air has a temperature of 40 degrees C. to 200 degrees C.

2. The processing device according to claim 1, wherein the air supply flowing into the bulk material has a temperature of between 40 degrees C. to 80 degrees C. when the processing device is configured for dust removal.

3. The processing device according to claim 1, wherein the air supply has a temperature of between 120 degrees C. to 200 degrees C. when the processing device is configured for crystallization of the bulk material

4. The processing device according to claim 1, further comprising a heating system with an electric heating device operable to heat said air supply.
